(19) United States
(12) Patent Application Publication
(10) Pub. No.: US 2008/0270483 A1
(43) Pub. Date: Oct. 30, 2008

(54) Storage Management System

(75) Inventors: Manoj KUMAR, Bangalore (IN); Srinath SASTRY, Bangalore (IN); Ajit MALAVIYA, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/109,294

(22) Filed: Apr. 24, 2008

(30) Foreign Application Priority Data
Apr. 30, 2007 (IN) 917/CHE/2007

(51) Int. Cl. G06F 12/00

(52) U.S. Cl. 707/200; 707/E17.01

(57) ABSTRACT

A storage management system is disclosed for managing storage of electronic files in a plurality of storage devices connected during use to the storage management system. The system comprises a storage server connectable to a plurality of storage devices and communicable with at least one client device through a network. Each storage device has storage device attributes indicative of characteristics of the storage device, and the storage server is arranged to export a virtual file structure indicative of the connected storage devices to the at least one client. During storage of a file the storage management system is arranged to compare desired storage requirements for the file with the storage device attributes of storage devices connected during use to the storage server, and to select a storage device for the file based on the comparison. When at least one smart storage device is connected to the storage server, the storage management system is arranged to cascade the desired storage requirements to the or each smart storage device.

### RELATED APPLICATIONS

This patent application claims priority to Indian patent application serial no. 917/CHE/2007, having title “A STORAGE MANAGEMENT SYSTEM”, filed on 30 Apr. 2007 in India, commonly assigned herewith, and hereby incorporated by reference.

### BACKGROUND OF THE INVENTION

A variety of data storage devices are currently available, ranging from simple local internal disks to complex data storage arrays provided with extensive data protection and high speed access mechanisms. Increasingly common are network enabled storage devices which are directly connectable to a computer network so as to provide centralized data access and storage for network clients. Such networked storages devices are commonly referred to as Network Attached Storage (NAS) systems. A NAS system incorporating a NAS server is capable of exporting different types of storage devices as a virtual file system that can be used by networked clients.

However, the networked clients see only the exported file system and are not aware of the actual characteristics of the storage devices. As a consequence, the clients are unable to distinguish between a complex expensive and efficient data storage system and low cost internal storage disks, and an effective Quality of Service (QoS) system is therefore difficult to implement.

### BRIEF DESCRIPTION OF THE DRAWINGS

The present invention will now be described, by way of example only, with reference to the accompanying drawings, in which:

FIG. 1 is a schematic diagram of a storage management system in accordance with an embodiment of the present invention;

FIG. 2 shows example Quality of Service (QoS) data for use with the storage management system shown in FIG. 1;

FIG. 3 shows example Quality of Service (QoS) translation rules for use with the storage management system shown in FIG. 1;

FIG. 4 shows example translated weighted storage device requirements generated by a policy manager of the storage management system shown in FIG. 1; and

FIG. 5 is a flow diagram illustrating a method of managing data storage in accordance with an embodiment of the present invention.

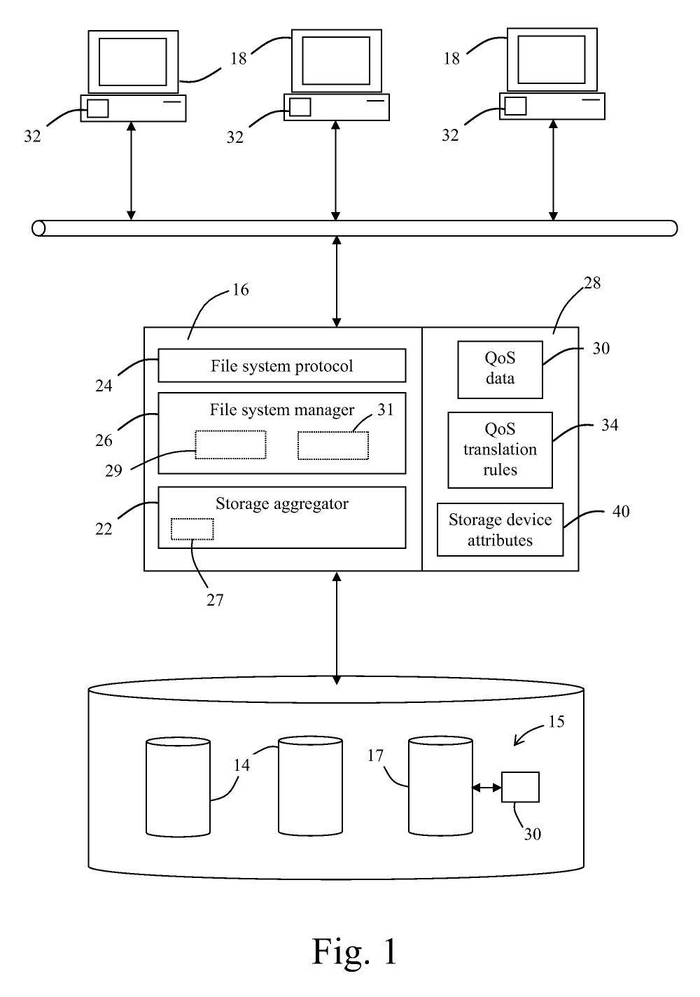

### DESCRIPTION OF AN EMBODIMENT OF THE INVENTION

Referring to the drawings, there is shown a storage management system 10 for managing data storage and retrieval operations with respect to a data storage system 12 of the type provided with a plurality of storage devices 14, 15. The types of storage device 14, 15 used may be different in that respective storage device properties such as cost of storage, access speed, redundancy or derived attributes such as optimized-for-multiple-reads, large-block-size may vary. Some of the storage devices used may include an internal disk, and/or a JBOD type storage device. In addition or alternatively, some of the storage devices used may be smart storage devices 15 which support policy based storage volume (LUN) creation. The smart storage device 15 includes a storage portion 17 and a processor portion 19 arranged to coordinate storage volume creation requests and QoS policy handling tasks. These devices 15 receive storage volume (LUN) creation requests as a QoS policy and create a LUN which best matches the client request. Example smart storage devices 15 include a storage array, an EVA type storage device, a NAS appliance and an iSCSI target.

The storage management system 10 comprises a storage server 16 connected to the storage system 12 and arranged to communicate with a plurality of clients 18 through a network 20.

In this example, the storage server 16 and the storage system 12 together form a Network Attached Storage (NAS) system.

The storage server 16 comprises a storage aggregator 22 which manages the storage devices 14, 15 and generates one or more virtual file structures incorporating the respective file structures of the storage devices 14, 15. The aggregated file structure is exported by the storage server 16 to the clients 18 associated with the network 20 using any suitable protocol 24 such as NFS or CIFS. The storage aggregator 22 also interacts with the storage devices 14, 15 to update storage device attributes 40 indicative of characteristics of the storage devices 14, 15.

The storage server 16 also comprises a file system manager 26 and a policy manager 28. The file system manager 26 intercepts file creation requests originating from the clients 18 and coordinates with the policy manager 28 to retrieve translated weighted storage device requirements 38 usable to determine the most appropriate storage device 14, 15 in which to store a file.

In one arrangement, the file system manager 26 includes a native file system 29 and a filter driver 31. The filter driver 31 intercepts I/O calls and coordinates with the policy manager 28 to retrieve translated weighted storage requirements 38 for the file. It passes translated weighted storage requirements 38 to the storage aggregator 22 to use to select a storage device 14, 15 which best matches the translated weighted storage requirements 38. The file system manager 26 then uses the native file system 29 to create the file on the selected storage device 14, 15. The main role of the file system manager 26 is to intercept I/O calls and coordinate with the policy manager 28 and the storage aggregator 22 to select an appropriate storage device 14, 15 for the file.

In an alternative example, the native file system 29 and the filter driver 31 are omitted and the file system manager 26 is itself a file system which coordinates with the policy manager 28 and the storage aggregator 22 and also performs file system operations and I/O operations in relation to the storage devices 14, 15.

On receipt of a request to create a file, the storage server 16 is arranged to select the most appropriate storage device 14, 15 for storage of the file using a predefined Quality of Service (QoS) policy in association with the policy manager 28 and the storage aggregator 22. In this example, the QoS policy is managed by the policy manager 28 which may be integral with or separate to the storage server 16.

The QoS policy is based on QoS data 30 and QoS translation rules 34. The QoS data 30 is user centric in that the QoS data defines characteristics for different file types based on the group that the user belongs to. In the present example, the characteristics include criticality and whether the data is transient. In this example, the QoS data 30 is created using policy creation applications 32 hosted by the clients 20, although it will be understood that the QoS data 30 may be created at any suitable location and using any suitable device, such as at the storage server 16.

The QoS translation rules 34 are file centric in that the QoS translation rules 34 generically define desired parameters for each file type, such as access time, redundancy, costs, large-block-size or write-once-read-many.

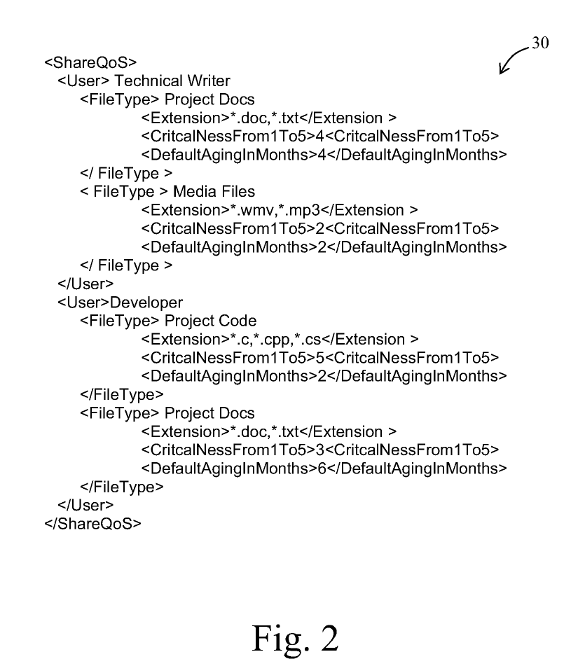

An example extract of QoS data 30 is shown in FIG. 2. The QoS data 30 defines QoS requirements specific to technical writer and developer user types. As can be seen, for “.doc” and “.txt” file types, the criticalness parameter is higher for a technical writer type of user than for a developer type of user.

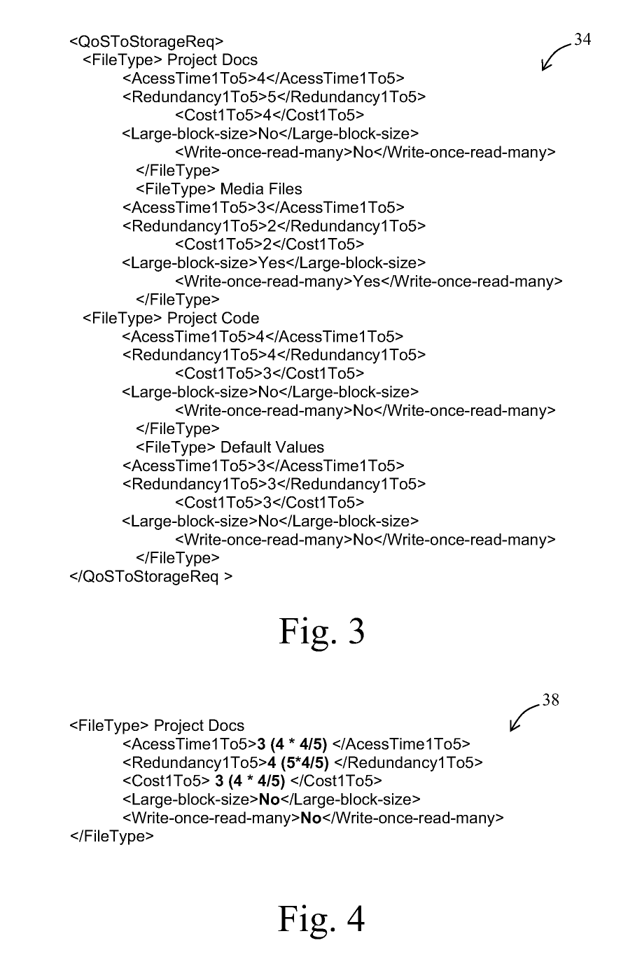

An example QoS translation rule 34 is shown in FIG. 3. The QoS translation rule 34 defines generic requirements for file types. As can be seen, the generic parameters in this example are “AccessTime1To5”, “Redundancy1To5”, “Cost1To5”, “Large-block-size” and “Write-once-read-many”.

The QoS translation rules 34 are constructed, for example by an administrator, based on statistical data. Ongoing feedback as to storage utilization may be given to the administrator to update the values specified in the translation rules as necessary.

The policy manager 28 also stores storage device attributes 40 which define characteristics of the storage devices 14, 15 forming part of the storage system 12. The storage device attributes are usually updated by the storage aggregator 22 by polling the storage devices 14, 15 for their attributes. The storage device attributes 40 may also be updated manually by an administrator.

In an example data storage 12 an internal disk, an EVA type storage device and a JBOD type storage device are provided. The storage device attributes 40 are as follows:

| | | | | Block | |
|---|---|---|---|---|---|
| Storage | | | | size | |
| type | Cost | Throughput | Reliability | (KB) | Redundancy |
| Internal | 2 | 5 | 4 | 128 | 5 |
| disk | | | | | |
| EVA | 5 | 4 | 4 | 64 | 4 |
| JBOD | 3 | 2 | 4 | 64 | 5 |

During use, the QoS data 30 indicative of requirements specific to user groups and the QoS translation rules 34 indicative of generic requirements for file types are used by the policy manager 28 to derive translated weighted storage device requirements 38, as shown in FIG. 4, indicative of both the user group specific QoS data 30 and the generic file specific QoS translation rules 34. In this example, when a particular file type is to be created by a user belonging to a particular user group, the policy manager 28 derives translated weighted storage device requirements 38 for the file proportionate to a criticalness value provided in the QoS data 30. This generates values based on the storage device parameters which are tailored towards the user group.

For example, as shown in FIG. 4, the criticalness value for the technical writer user group for project documents is 4. This value is converted to a proportional criticalness value by expressing the value relative to a maximum criticalness score of 5, and each parameter in the QoS translation rule 34 is multiplied by the proportional value to give a weighted storage requirement value.

In the present example, project documents are given a criticalness value of 4 out of 5 for the technical writer user group, and the “AccessTime1To5”, “Redundancy1To5”, “Cost1To5”, “Large-block-size” and “Write-once-read-many” parameters for project documents in the QoS translation rule 34 are 4, 5, 4, “No” and “No” respectively. Each numerical value is then multiplied by 4/5 so as to produce translated weighted storage requirements 38, in the present case 3.2, 4 and 3.2 (rounded to 3, 4 and 3).

The translated weighted storage requirements 38 are used by the storage aggregator 22 to select the most appropriate storage device for a file. The storage aggregator 22 selects a storage device by comparing the translated weighted storage requirements 38 for the file with the storage device attributes 40 associated with the storage devices 14, 15.

In the above example, the translated weighted storage requirements for a technical writer wishing to create a project document are 3, 4, 3, No and No. For AccessTime=3, Redundancy=4 and Large-block-size=No the most appropriate storage device given by the storage device attributes 40 above is EVA.

It will be appreciated that the software language used to define the QoS data 30 and QoS translation rules 34 is in this example non-proprietary so as to ensure interoperability between storage servers and clients. In the present embodiment the software language used is XML.

It will be understood that the process of comparing QoS requirements with weighted storage device attributes occurs only when a file is created. After file creation, a conventional file handler may be used and the policy manager 28 is not required.

If any smart storage device 15 is attached to the storage server 16, the storage aggregator 22 creates a new QoS policy 27 for the smart storage device 15 based on the translated weighted storage requirements 38 and cascades the new QoS policy 27 to the smart storage device 15.

When the smart storage device 15 receives the QoS policy 27 from the storage aggregator 22, the smart storage device 15 acknowledges the request by communicating to the storage aggregator 22 the type of storage volume that the smart storage device 15 can create based on the QoS policy 27 sent by the storage aggregator 22. After receiving acknowledgements from all smart storage devices 15, the storage aggregator 22 selects the most appropriate storage device to create the storage volume. If needed the storage aggregator 22 negotiates with the smart storage device 15 to find the best match for the translated storage requirement by changing the QoS policy 27 for the smart storage device. Cascading QoS policy 27 can be implemented only when the storage device supports QoS based management. Otherwise the storage aggregator 22 will select a device based on the data available in the storage device attributes 40.

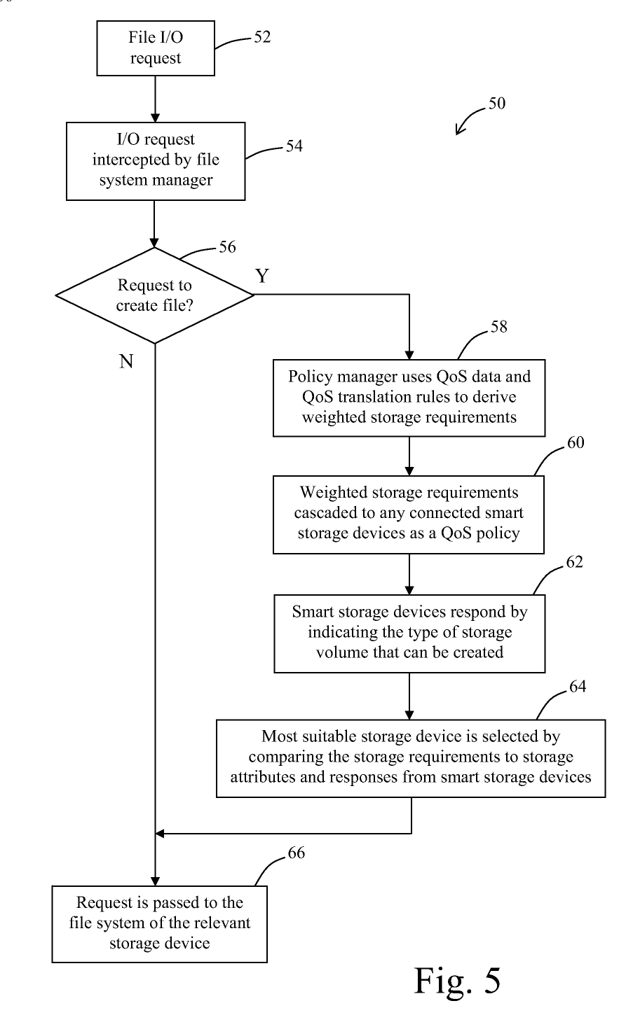

An example method of managing file data storage is shown in a flow diagram 50 in FIG. 5 which illustrates steps 52 to 66 of creating a file on the storage system 12.

On receipt of a file I/O request from a user associated with a particular group wishing to carry out an operation in relation to a particular file, the file system manager 26 intercepts the request and determines whether the request is for creation of or to open a file or for execution of other file operations such as file retrieval. If the request is not for creation of a file, the request is handled by a conventional file handler. If the request is for creation or to open of a file, the policy manager 28 extracts the relevant values from the QoS data 32 specific to the user group and file type concerned, and generates translated weighted storage requirements 38 using the extracted values and the QoS translation rules 34. The translated weighted storage requirements are then cascaded to any connected smart storage device 15 as a new QoS policy 27 and each smart storage device responds by indicating the type of storage volume that the smart storage device(s) can create based on the cascaded QoS policy 27. The translated weighted storage requirements are then compared with the storage device attributes 40 of the non-smart storage devices 14 and the responses from the smart storage device(s) 15 and a best fit storage device 14, 15 for the file is selected. If a smart storage device 15 is selected, the selected smart storage device 15 creates the desired storage volume for the file according to the cascaded QoS policy 27.

It will be understood that the present embodiment is primarily implemented using one or more software applications. As such, appropriate components would be included in the storage management system in order to enable execution of the applications, such as a processor and associated memory. However, it will be understood that as an alternative, the functions of the storage management system may be implemented at least partly in hardware.

Modifications and variations as would be apparent to a skilled addressee are deemed to be within the scope of the present invention.

1. A storage management system for managing storage of electronic files in a plurality of storage devices connected during use to the storage management system, said system comprising:
a storage server connectable to a plurality of storage devices and communicable with at least one client device through a network, each storage device having storage device attributes indicative of characteristics of the storage device, and the storage server being arranged to export a virtual file structure indicative of connected storage devices to the at least one client;
wherein during storage of a file the storage management system is arranged to compare desired storage requirements for the file with the storage device attributes of storage devices connected during use to the storage server, and to select a storage device for the file based on the comparison; and
wherein when at least one smart storage device is connected to the storage server, the storage management system is arranged to cascade the desired storage requirements to the or each smart storage device.

2. A storage management system as claimed in claim 1, wherein the storage management system is arranged to cascade the desired storage requirements to the or each smart storage device connected during use to the storage management system in the form of a Quality of Service (QoS) policy.

3. A storage management system as claimed in claim 2, wherein the storage management system comprises at least one smart storage device, the at least one smart storage device being arranged to create a storage volume on the smart storage device using the QoS policy when the smart storage device is selected by the storage server.

4. A storage management system as claimed in claim 3, wherein each smart storage device is arranged to send to the storage server an acknowledgement communication indicative of the type of storage volume that the smart storage device can create, and the storage server is arranged to select a storage device for the file using the acknowledgement communication.

5. A storage management system as claimed in claim 4, wherein the storage server is arranged to modify the QoS policy cascaded to a smart storage device in order to better match the QoS policy with the selected smart storage device.

6. A storage management system as claimed in claim 1, wherein the storage device requirements are derived from Quality of Service (QoS) data indicative of storage requirements specific to at least one user and Quality of Service (QoS) translation rules indicative of storage requirements specific to file types.

7. A storage management system as claimed in claim 6, wherein the storage device requirements are receivable from a client in communication with the storage server through a network.

8. A storage management system as claimed in claim 6, wherein the QoS data includes a criticalness value, the QoS translation rules comprise translation rules values, and the storage device requirements derived from the QoS data and the QoS translation rules are translated weighted storage device requirements derived by multiplying at least some of the translation rules values by the criticalness value.

9. A storage management system as claimed in claim 8, wherein the QoS translation rules include desired parameters for a file type including access time, redundancy, cost, large-block-size and/or write-once-read-many.

10. A storage management system as claimed in claim 6, wherein the QoS data and the QoS translation rules conform to the same software language format.

11. A storage management system as claimed in claim 10, wherein the software language format is XML.

12. A storage management system as claimed in claim 8, further comprising a policy manager arranged to generate the translated weighted storage device requirements using the QoS data and the QoS translation rules.

13. A storage management system as claimed in claim 1, further comprising a storage aggregator arranged to generate and export the virtual file structure indicative of the connected storage devices to the at least one client, and to select a storage device for a file based on the comparison between the desired storage requirements for the file and the storage device attributes of storage devices connected during use to the storage server.

14. A storage management system as claimed in claim 11, further comprising a file system manager arranged to intercept file creation requests, to pass desired storage requirements for a file to the storage aggregator, and to coordinate creation of the file on a selected storage device.
